(19) United States
(12) Patent Application Publication
(10) Pub. No.: US 2013/0268797 A1
(43) Pub. Date: Oct. 10, 2013

(54) POWER-OFF PROTECTION CIRCUIT AND ELECTRONIC DEVICE WITH POWER-OFF PROTECTION CIRCUIT

(71) Applicant: XING-HUA TANG, Shenzhen City (CN)

(72) Inventor: XING-HUA TANG, Shenzhen City (CN)

(21) Appl. No.: 13/649,609

(22) Filed: Oct. 11, 2012

(30) Foreign Application Priority Data
Apr. 6, 2012 (CN) 201210099011.0

(51) Int. Cl. G06F 1/26

(52) U.S. Cl. 713/340

(57) ABSTRACT

A power-off protection circuit includes a power-off detection module and a delay module. The power-off detection module is connected to a system power port of an electronic device and determines when the system power port is at a low voltage, as an indication that the electronic device is being powered off. A power-off signal is produced when the system power port is at a low voltage. The delay module transmits the voltage from the system power port to a processing unit and an EEPROM when the electronic device is powered on, and provides a voltage to the processing unit and the EEPROM for a period of time when the electronic device is powered off, allowing the processing unit and the EEPROM to continue working for the period of time, thus enabling the processing unit controls to store parameters set but not yet stored by a user into the EEPROM.

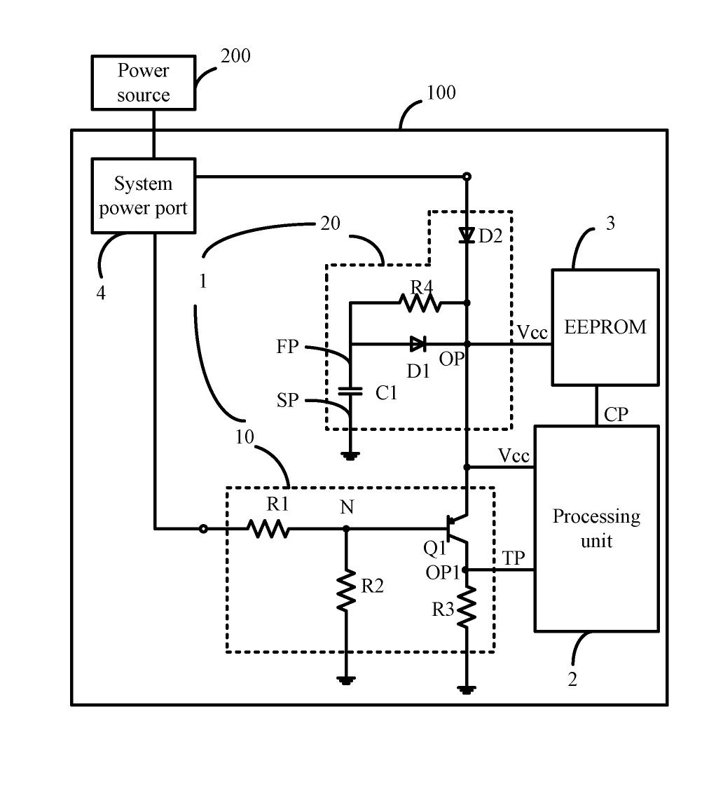

### BACKGROUND

1. Technical Field

The present disclosure relates to circuits and, particularly, to a power-off protection circuit and an electronic device with the power-off protection circuit.

2. Description of Related Art

In electronic devices, some parameters, such as volume, display resolution, and display style, can be set by a user, and data relating to the set parameters are stored in an Electrically Erasable Programmable Read-Only Memory (EEPROM). However, if the electronic device is powered off suddenly as the user is setting the parameters, the parameters currently being set by the user might not be stored in time, which may leads to the parameters stored in the EEPROM being outside of an allowable range, comparing to those parameters newly set by the user, and the electronic device maybe could not produce a visible display or output audio signals properly.

A power-off protection circuit and an electronic device with the power-off protection circuit, to overcome the described limitations is thus needed.

### BRIEF DESCRIPTION OF THE DRAWINGS

Many aspects of the present disclosure are better understood with reference to the following drawing. The components in the drawing are not necessarily drawn to scale, the emphasis instead being placed upon clearly illustrating the principles of the present disclosure.

The figure is a circuit diagram of an electronic device with a power-off protection circuit, in accordance with an exemplary embodiment.

### DETAILED DESCRIPTION

Embodiments of the present disclosure will be described with reference to the drawing.

The figure illustrates an electronic device 100 of the embodiment. The electronic device 100 includes a power-off protection circuit 1, a processing unit 2, an Electrically Erasable Programmable Read-Only Memory (EEPROM) 3, and a system power port 4.

The system power port 4 is electrically connected to a power source 200 and outputs a voltage to power elements of the electronic device 100, such as the processing unit 2 and the EEPROM 3, when the electronic device 100 is powered on. When the electronic device is powered off, the system power port 4 outputs no power and is at a low voltage. In the embodiment, the power source 200 can be a power adapter or a battery.

The power-off protection circuit 1 includes a power-off detection module 10 and a delay module 20. The power-off detection module 10 is connected to the system power port 4, and detects a voltage of the system power port 40 to determine whether the electronic device 100 is powered off. In detail, when the power-off detection module 10 determines that a low voltage exists at the system power port 4, a further determination is made that the electronic device 100 is powered off and a power-off signal is output to the processing unit 2. As long as the system power port 4 is outputting a high voltage, the power-off detection module 10 determines the electronic device 100 is powered on and does not output any power-off signal.

The delay module 20 is connected to the processing unit 2, the EEPROM 3, and the system power port 4. When the electronic device 100 is powered on, the delay module 20 transmits the voltage from the system power port 4 to the processing unit 2 and the EEPROM 3, then powers on the processing unit 2 and the EEPROM 3. When the electronic device 100 is powered off, the delay module 20 provides a voltage to the processing unit 2 and the EEPROM 3 for a period of time, thereby maintaining the processing unit 2 and the EEPROM 3 in a working state for the period of time.

The processing unit 2 stores parameters set by a user into the EEPROM 3 when receiving a power-off signal. Because the processing unit 2 and the EEPROM 3 remain powered on for the period of time after the electronic device 100 has been powered off, then the processing unit 2 is able to store the parameters set by the user into the EEPROM 3 even when the electronic device 100 is powered off suddenly.

In detail, as shown in the figure, the power-off detection module 10 includes a first resistor R1, a second resistor R2, a positive-negative-positive bipolar junction transistor (pnp BJT) Q1, and a third resistor R3. The first resistor R1 and the second resistor R2 are connected in series between the system power port 4 and ground. A connection node N of the first resistor R1 and the second resistor R2 is connected to a base of the pnp BJT Q1, a collector of the pnp BJT Q1 is grounded via the third resistor R3. An emitter of the pnp BJT Q1 is connected to the delay module 20. The emitter of the pnp BJT Q1 constitutes an output port OP1 of the power-off detection module 10. In another embodiment, the pnp BJT Q1 can be replaced by a P-channel metal-oxide-semiconductor field-effect transistor.

The delay module 20 includes a fourth resistor R4, a capacitor C1, and a first diode D1. The fourth resistor R4 is electrically connected between the system power port 4 and a first terminal FP of the capacitor C1, a second terminal SP of the capacitor C1 is grounded. The first terminal FP of the capacitor C1 is also electronically connected to voltage input ports Vcc of the processing unit 2 and the EEPROM 3 via the first diode D1. An anode of the first diode D1 is connected to the first terminal FP of the capacitor C1, and a cathode of the first diode D1 is connected to the voltage input ports Vcc of the processing unit 2 and the EEPROM 3. The cathode of the first diode D1 constitutes an output port OP of the delay module 20. The emitter of the pnp BJT Q1 is connected to the output port OP of the delay module 20.

The processing unit 2 includes a trigger pin TP and a control pin CP, the trigger pin TP is connected to the collector of the pnp BJT Q1 and receives the power-off signal from the power-off detection circuit 10. The control pin CP is connected to the EEPROM 3, and outputs a control signal to the EEPROM 3 to control the EEPROM 3 to store the parameters set by the user when the trigger pin TP receives a power-off signal.

When the electronic device 100 is powered on, the system power port 4 outputs the voltage of the power source 200 to charge the capacitor C1 via the fourth resistor R4 and to power the processing unit 2 and the EEPROM 3 via the output port OP.

At the same time, the connection node N of the resistor R1 and the second resistor R2 is at high voltage, and the base of the pnp BJT Q1 connected to the connection node N is also at high voltage. Thus the pnp BJT Q1 is turned off, the collector of the pnp BJT Q1 is grounded via the third resistor R3 and outputs a low voltage. In the embodiment, the power-off signal is a high voltage signal. When the trigger pin TP of the processing unit 2 receives the low voltage, the processing unit 2 does nothing.

When the electronic device 100 is powered off, the system power port 4 stops outputting the voltage of the power source 200. During discharge of the capacitor C1, a voltage is output to power the processing unit 2 and the EEPROM 3 via first diode D1 and the output port OP. The emitter of the pnp BJT Q1 remains at high voltage by obtaining the voltage of the output port OP. The base of the pnp BJT Q1 is grounded via the second resistor R2 and at low voltage, thus the pnp BJT Q1 is turned on, and the collector of the pnp BJT Q1 obtains a high voltage from the output port OP and outputs a high voltage power-off signal.

The trigger pin TP of the processing unit 2 obtains the high voltage power-off signal. As described above, the processing unit 2 outputs the control signal to the EEPROM 3 via the control pin CP to control the EEPROM 3 to store the parameters set by the user, when the trigger pin TP receives a power-off signal.

In the embodiment, the delay module 20 also includes a second diode D2, an anode of the second diode D2 is connected to the system power port 4, and a cathode of the second diode D2 is connected to the output port OP of the delay module 2. When the electronic device 100 is turned off, the second diode D2 prevents the capacitor C1 outputting and feedbacking a voltage to the system power port 4.

In the embodiment, the electronic device 100 can be a mobile phone, a digital camera, a digital photo frame, an electronic reader, or a digital video disk player, for example.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A power-off protection circuit, configured to output a voltage to an electronic device for a period of time when the electronic device is powered off, the power-off protection circuit comprising:
a power-off detection module connected to a system power port of the electronic device, configured to detect whether the electronic device is powered off by detecting a voltage of the system power port, and produce a power-off signal to a processing unit when determining the electronic device is powered off by detecting the system power port is at a low voltage; and
a delay module, configured to transmit the voltage from the system power port to the processing unit and an Electrically Erasable Programmable Read-Only Memory (EEPROM) when the electronic device is powered on, and provide voltage to the processing unit and the EEPROM for a period of time when the electronic device is powered off, thereby maintaining the processing unit and the EEPROM working for the period of time, thus to enable the processing unit to control to store parameters set by a user into the EEPROM when receiving the power-off signal.

2. The power-off protection circuit according to claim 1, wherein the power-off detection module comprises a first resistor, a second resistor, a positive-negative-positive bipolar junction transistor (pnp BJT), and a third resistor; the first resistor and the second resistor are connected between the system power port and ground in series, a connection node of the first resistor and the second resistor is connected to a base of the pnp BJT, a collector of the pnp BJT is grounded via the third resistor R3, an emitter of the pnp BJT is connected to the delay module.

3. The power-off protection circuit according to claim 2, wherein the delay module comprises a fourth resistor, a capacitor, and a first diode, the fourth resistor is electrically connected between the system power port and a first terminal of the capacitor, a second terminal of the capacitor is grounded, the first terminal of the capacitor is also electronically connected to voltage input ports of the processing unit and the EEPROM via the first diode.

4. The power-off protection circuit according to claim 3, wherein an anode of the first diode is connected to the first terminal of the capacitor, a cathode of the first diode is connected to the voltage input ports of the processing unit and the EEPROM, and the emitter of the pnp BJT.

5. The power-off protection circuit according to claim 4, wherein the delay module further comprises a second diode, an anode of the second diode is connected to the system power port, a cathode of the second diode is connected to the third resistor and the cathode of the first diode.

6. The power-off protection circuit according to claim 4, wherein the power-off signal is a high voltage signal, when the electronic device is powered on, the capacitor is charged and the processing unit and the EEPROM is powered on by receiving the voltage from the system power port; the connection node is at high voltage, and the base of the pnp BJT connected to the connection node is at high voltage, then the pnp BJT is turned off, the collector of the pnp BJT is grounded via the resistor and outputs a low voltage.

7. The power-off protection circuit according to claim 6, wherein when the electronic device is powered off, the power system port stops outputting the voltage, the capacitor is discharged and maintains to output the voltage to power the processing unit and the EEPROM via first diode, the emitter of the pnp BJT is at high voltage by obtaining the voltage of the capacitor, the base of the pnp BJT is grounded via the second resistor and at low voltage, then the pnp BJT is turned on, the collector of the pnp BJT obtains the high voltage, and outputs the high voltage power-off signal to the processing unit.

8. An electronic device comprising:
a system power port, configured to connect to a power source and outputs a voltage of the power source to power elements of the electronic device when the electronic device is powered on, wherein, when the electronic device is powered off, the system power port does not output the voltage of the power source and is at a low voltage;
a processing unit;
an Electrically Erasable Programmable Read-Only Memory (EEPROM); and
a power source detection circuit comprising:
a power-off detection module connected to the system power port of the electronic device, configured to detect whether the electronic device is powered off by detecting the voltage of the system power port, and output a power-off signal to the processing unit when determining the electronic device is powered off by detecting the system power port is at a low voltage; and
a delay module, configured to transmit the voltage from the system power port to the processing unit and the EEPROM when the electronic device is powered on, and provide voltage to the processing unit and the EEPROM for a period of time when the electronic device is powered off, thereby maintaining the processing unit and the EEPROM working for the period of time;
wherein, the processing unit controls to store parameters set by a user into the EEPROM when receiving the power-off signal.

9. The electronic device according to claim 8, wherein the power-off detection module comprises a first resistor, a second resistor, a positive-negative-positive bipolar junction transistor (pnp BJT), and a third resistor; the first resistor and the second resistor are connected between the system power port and ground in series, a connection node of the first resistor and the second resistor is connected to a base of the pnp BJT, a collector of the pnp BJT is grounded via the third resistor R3, an emitter of the pnp BJT is connected to the delay module.

10. The electronic device according to claim 9, wherein the delay module comprises a fourth resistor, a capacitor, and a first diode, the fourth resistor is electrically connected between the system power port and a first terminal of the capacitor, a second terminal of the capacitor is grounded, the first terminal of the capacitor is also electronically connected to voltage input ports of the processing unit and the EEPROM via the first diode.

11. The electronic device according to claim 10, wherein an anode of the first diode is connected to the first terminal of the capacitor, a cathode of the first diode is connected to the voltage input ports of the processing unit and the EEPROM, and the emitter of the pnp BJT.

12. The electronic device according to claim 11, wherein the delay module further comprises a second diode, an anode of the second diode is connected to the system power port, a cathode of the second diode is connected to the third resistor and the cathode of the first diode.

13. The electronic device according to claim 11, wherein the processing unit comprises a trigger pin and a control pin, the trigger pin is connected to the collector of the pnp BJT, the control pin is connected to the EEPROM.

14. The electronic device according to claim 13, wherein the power-off signal is a high voltage signal, when the electronic device is powered on, the capacitor is charged, and the processing unit and the EEPROM is powered on by the system power port, the connection node is at high voltage, and the base of the pnp BJT connected to the connection node is at high voltage, then the pnp BJT is turned off, the collector of the pnp BJT is grounded via the resistor and outputs a low voltage.

15. The electronic device according to claim 14, wherein when the electronic device is powered off, the power system port stops outputting the voltage, the capacitor is discharged and maintains to output the voltage to power the processing unit and the EEPROM via first diode, the emitter of the pnp BJT is at high voltage by obtaining the voltage of the capacitor, the base of the pnp BJT is grounded via the second resistor and at low voltage, then the pnp BJT is turned on, the collector of the pnp BJT obtains the high voltage, and outputs the high voltage power-off signal to the trigger pin of the processing unit, the processing unit outputs a control signal to the EEPROM via the control pin to control the EEPROM to store the parameters set by the user when the trigger pin receives the power-off signal.

16. The electronic device according to claim 8, wherein the electronic device is one selected from a group consist of a mobile phone, a digital camera, a digital photo frame, an electronic reader, and a digital video disk player.
